(19) United States
(12) Patent Application Publication
(10) Pub. No.: US 2008/0059209 A1
(43) Pub. Date: Mar. 6, 2008

(54) System and method for providing legal services over a network

(76) Inventor: Lou Larsen, Stuart, FL (US)

Correspondence Address: MCHALE & SLAVIN, P.A., 2855 PGA BLVD, PALM BEACH GARDENS, FL, 33410, US

(21) Appl. No.: 11/469,915

(22) Filed: Sep. 5, 2006

(51) Int. Cl. G06Q 10/00; G06Q 30/00

(52) U.S. Cl. 705/1

(57) ABSTRACT

A system and method for providing legal services by licensed and practicing lawyers to clients of a law firm. The system includes means facilitate the acquisition information entered by the client and specific legal service requests of the client. The system includes means for live, online communications between a client and an attorney to resolve any issues. Once the client's requests have been processed and review by an attorney the proper documents are prepared and sent to the client.

### FIELD OF THE INVENTION

The present invention relates to a system and method for providing legal services over the Internet with the assistance of a realtime person to answer questions and provide additional information.

### BACKGROUND OF THE INVENTION

Businesses and individuals require legal services to manage their legal affairs. The cost of these services can sometime be staggering and the scheduling of these services can also be inconvenient. As a result some of the legal work may be handled by uninitiated employees or the individuals themselves. Without the benefit of proper legal training or competent legal advice their actions could result in an increase in the businesses' risk of incorrect legal decisions and/or potentially compromising the businesses' rights.

Cost limitations are not the only reasons for small businesses and individuals not to seek professional legal services at law firms. Many people are currently wary of attorneys based on unpleasant and costly past experiences or experiences of others. These individuals would prefer to manage their own legal affairs, however, until now, they have lacked the resources to do so.

### DESCRIPTION OF THE PRIOR ART

Do-it-yourself books, form libraries and software have been available with generic legal documents and forms. Although these forms may be useful for some situations, most situations require modification of the language in the forms or documents dependent on the circumstances of the transaction or situation. The untrained or uninitiated individual does not realize that modifications to the generic language is required for specific situations. In addition, if they do realize that the language should be changed, they do not know how to change it. The do-it-yourself books and software do not provide sufficient information and guidance to make the correct modifications. Many of the forms use arcane legal language, which are written for experienced attorneys, making them incomprehensible to the untrained or uninitiated person.

Recently the Internet has provided ready access to these legal forms and documents. Web sites have emerged which provide these forms and documents free or at a very low cost. Unfortunately, these Web sites suffer from the same problems as prior publications and software. There is no guidance or instructions for the correct use of these documents.

Another recent innovation for network systems which process information provided thereto by a client is the interrogative interface. This interface permits the Web sites or Internet based systems to process information provided by a client by presenting the client a questionnaire or form to complete. Examples of these include questionnaires posed to clients in order to register a product or effect a purchase of a product. The questions and/or responses may be communicated by any of various input devices including keyboards, touch screens, handwriting recognition systems, speech recognition systems and pointing devices for example.

An example of this type of network system is disclosed in U.S. Pat. No. 6,594,633, the disclosure of which is incorporated by reference. This patent describes a real estate computer network to facilitate a real estate transaction between a buyer and a seller by providing electronic communication between the parties. Electronic communication is also provided between the buyer, seller and a third party real estate facilitators (e.g., lawyer, mortgage provider, title provided) over a network which may include the Internet. While this permits the buyer and seller to instantly communicate with each other, the availability of the third party real estate facilitators is not guaranteed to be instantaneous or timely. For example, if the buyer wants to modify the sales contract an attorney or licensed real estate agent may not be currently available to advise the buyer which specific changes should be made to the contract. Even if they contact the buyer in 24 to 48 hours, another offer may be made on the property and the seller may accept the second offer. Also, if the attorney or real estate agent cannot instantaneously communicate with the buyer, they may not completely understand the buyer's reasons for changing the contract and may not be able to provide the correct legal advice.

Another example of a network system which provides a service to a client is U.S. Pat. No. 6,366,925. This patent describes a legal services network that automates the receipt of information from a client, provides a secure attorney-client communication channel and a data base format that enables an attorney to administer a plurality and variety of matters. This system may be implemented over a private network or over the Internet. The system is currently available on the Internet at the URL “www.visanow.com”. Once a client logs onto the system they can register and be assigned an account number and select a password. The client can then select to file an immigration/naturalization application or apply for a visa. Should they have any legal questions they would select the “E-Consultation^{SM}” page and present the question. The client is then notified via e-mail that a response to their question has been posted on the network. The client must then log onto the network and access their account to view the response. This delay between the posting of a question and receipt of a response can be very time consuming and render the system difficult to use. What is needed is a system that does not require the client to log off the system and back on again to receive the answers to their questions.

U.S. Published Application No. 2004/0019496 discloses a network based system for law practice information management. A Wide Area Network connects in-house counsel, outside counsel, other entities, a legal information system, an e-mail system and reports. The individuals can access information and provide information to any portion of the system to which they have permission to access. The system may also be accessed over the Internet using a public switched telephone network (PSTN). While this system may provide access to law practice information it is not intended for a member of the general public to query a law practice and obtain certain documents.

U.S. Published Application No. 2002/0143569 discloses a system for rendering legal services online, attorneys can become affiliated with the system and build their own practice. U.S. Published Application No. 2002/0019741 is another example of an online legal service system.

These prior art systems do not provide a network based system which allows someone who is not an attorney to seek and receive legal services over a network, such as the internet, at any time and at the user's convenience.

### SUMMARY OF THE INVENTION

The present invention is directed to a system for the provision of legal services which may be accessed by a client at any time.

Accordingly, it is an objective of the instant invention to provide a system of legal services which a client may access at any time.

It is a further objective of the instant invention to provide a secure attorney-client channel of communications.

It is yet another objective of the instant invention to provide a real-time channel of communications between a client and an attorney via a computer.

It is a still further objective of the invention to provide a means to accept receipt of a retainer by a client and acknowledgment by a client that they are engaging a provider to perform legal services.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an introduction section of a system in accordance with an embodiment of the instant invention;

FIG. 2 is the Order Now section page of a system in accordance with an embodiment of the instant invention;

FIG. 3 is the section page which contains information regarding the products and pricing;

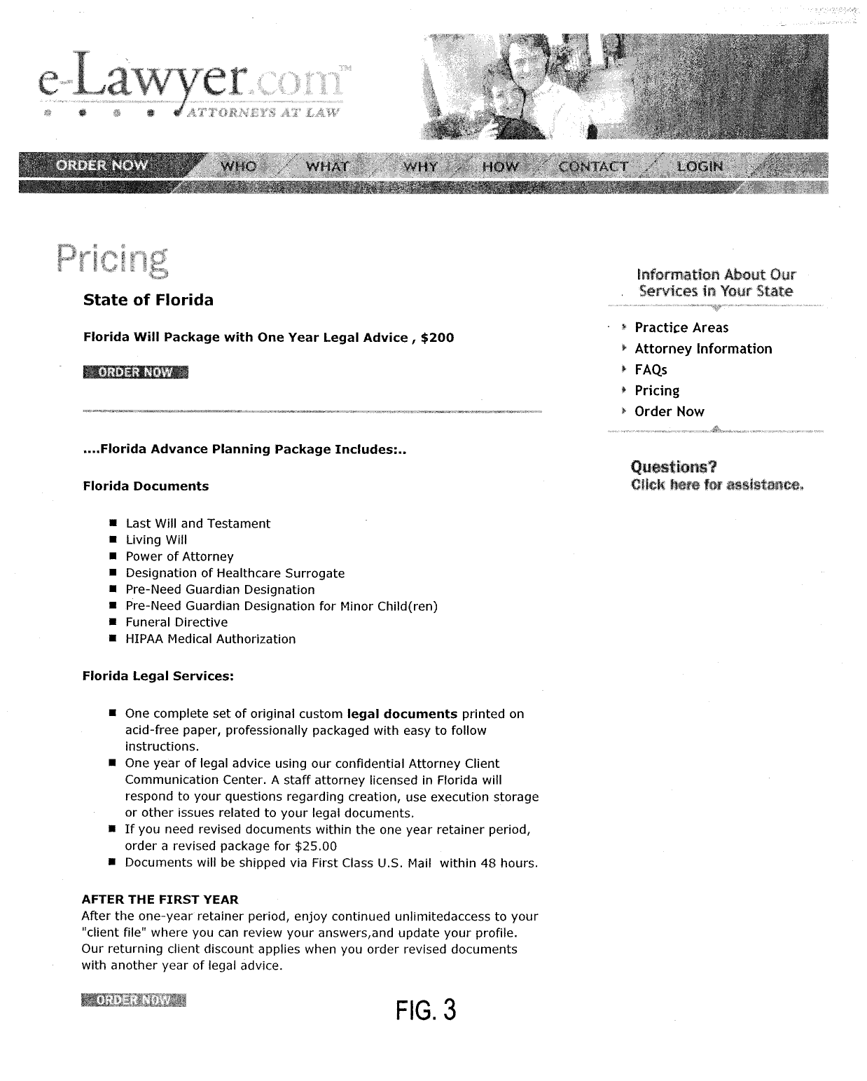

FIG. 4 is the Login section page of a system in accordance with an embodiment of the instant invention;

FIG. 5 is the Client Communications page of a system in accordance with an embodiment of the instant invention;

FIG. 6 is the Contact Us page of a system in accordance with an embodiment of the instant invention;

FIG. 7 is the additional window to provide communications between a client and an attorney;

FIG. 8 is a flowchart which represents the process of utilizing the instant invention; and

FIG. 9 is a continuation of the flowchart of FIG. 8.

### DETAILED DESCRIPTION OF THE INVENTION

While the present invention is susceptible of embodiment in various forms, there is shown in the accompanying drawings and will herein after be described a presently preferred embodiment with the understanding that the present disclosure is to be considered an exemplification of the invention and is not intended to limit the invention to the specific embodiments illustrated.

The system of the present invention is implemented for on-line user access over a computer network, preferably the Internet and in particular the World Wide Web (www), using commonly available Internet access and browser software, such as Microsoft's Windows operating system and either Netscape Navigator or Microsoft's Internet Explorer browser. The system may also be implemented on local area networks, wide area networks, intranets and computers providing direct dial-up, DSL and cable access to users. The system may include HTML, scripts (eg. JAVA and VB), cgi applications, activeX data objects, applets, database software, databases and the like. The system may also be implemented on a wide area network or private network such as a plurality of kiosks located in a particular chain of supermarkets or banks.

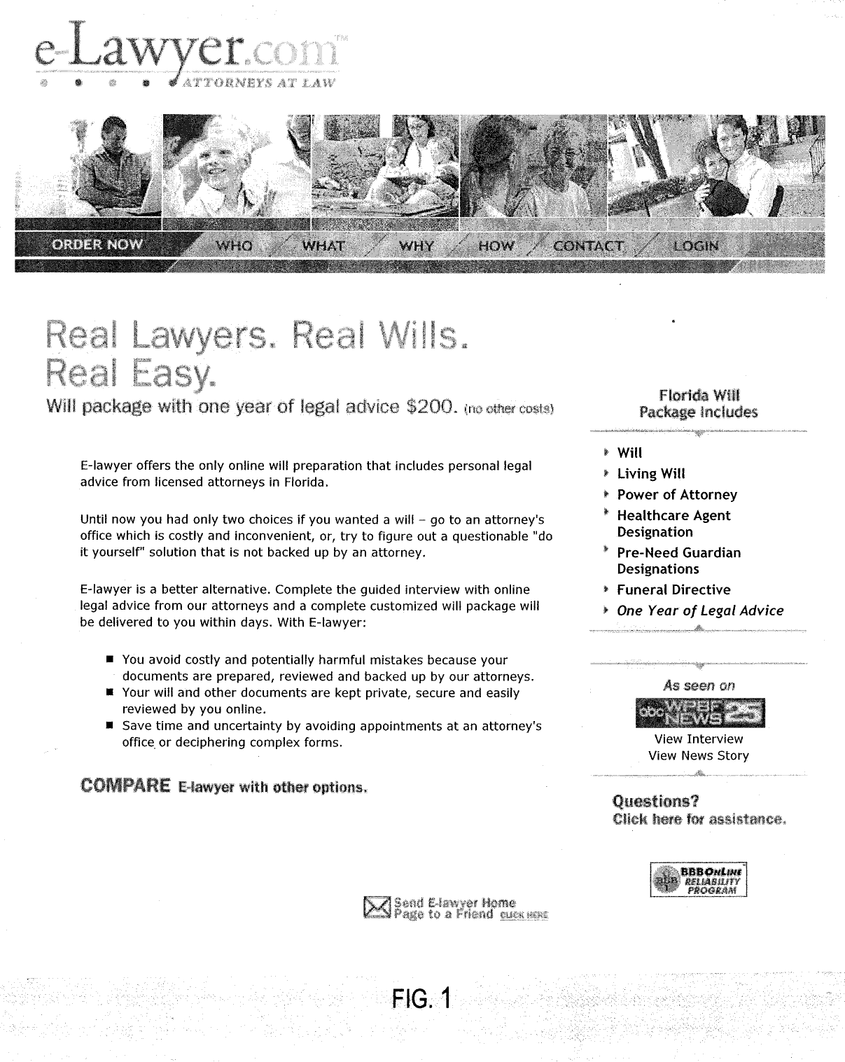

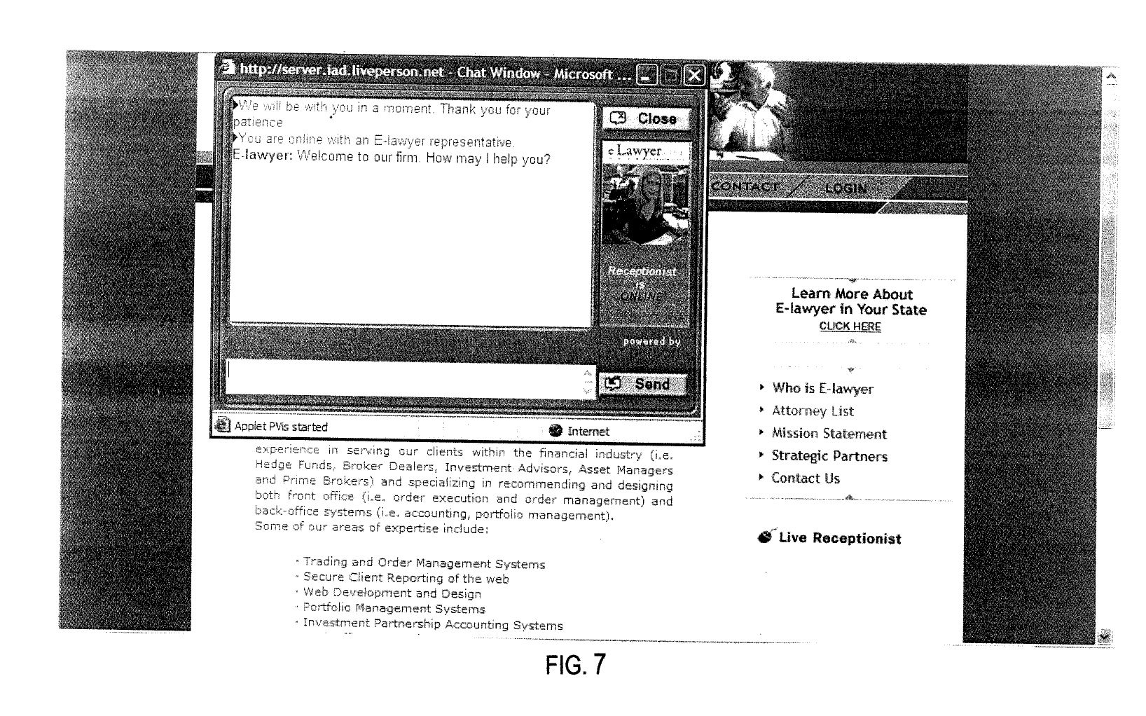

The system is preferably divided into discrete sections to facilitate navigation of the website of the user. Referring to FIG. 1 the system may include the following sections; “Order Now”; “Who”; “What”; “Why”; “How”; “Contact”; and “Login”. The unique feature of E-Lawyer is that on each web page there is a link for any questions that the user may have at that time. The preferred link is “Questions? Click here for assistance”. This will bring the user to a new window where they can have a realtime, online dialogue with a live person or ask a question and receive an answer at a later time via e-mail or other means. This new window is illustrated in FIG. 7.

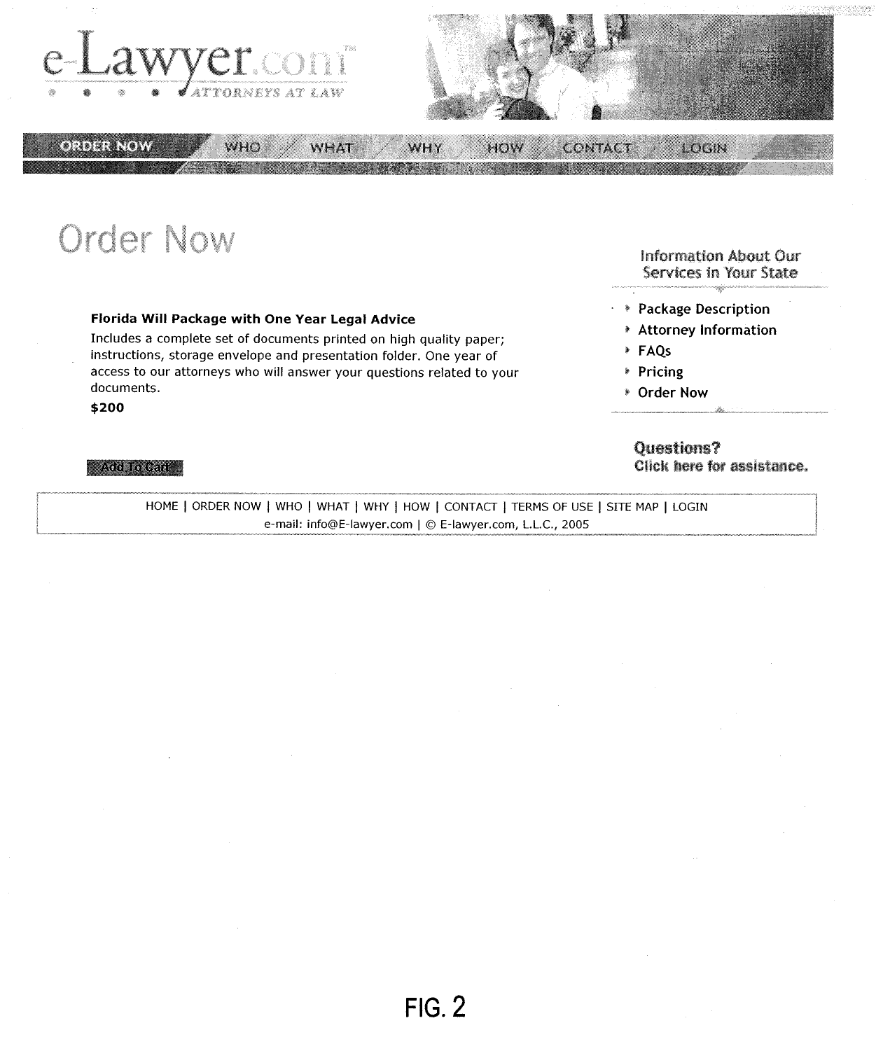

The “Order Now” section, illustrated in FIG. 2, contains a brief description of the package of legal documents which are supplied dependent on the state in which the user resides. After the user selects the Add to Cart link, a complete description of the documents necessary for Advance Planning directives for an individual. For example, in the state of Florida these documents include Last Will and Testament, Living Will, Power of Attorney, Designation of Healthcare Surrogate, Pre-Need Guardian Designation, Pre-Need Guardian Designation for Minor Child(ren), Funeral Directive and HIPAA Medical Authorization. Also, one year of legal advice is included. This section also includes information about the attorneys licensed to practice in the state in which the documents are to be prepared and executed; Frequently Asked Questions; pricing or cost of the package; and a link to the “Order Now” web page.

The “Who” section is further broken down into “Who is E-Lawyer”; “Attorney List”; “Mission Statement”; “Strategic Partners”; and “Contact Us” subsections. This section includes information about the founders of “E-Lawyer”, a list of attorneys affiliated with “E-Lawyer”, the Mission Statement of the company, a list of Strategic Partners or other companies who have partnered with E-Lawyer to establish the website, and a link to the web page where the user can ask questions to the attorneys and receive answers via e-mail or the telephone.

The “What” section is further broken down into “What We Do”; “Services”; “Fee Structure”; and “Compare E-Lawyer” subsections. These contain descriptions of the services provided by E-Lawyer; the cost of these services; and a comparison of E-Lawyer to a non-law website, a “will kit” and a traditional law office. This will give the potential client a quick way to compare and evaluate the different avenues available for advanced planning, etc.

The “Why” section is further broken down into “Why E-Lawyer” and “Why You Need Advance Planning” subsections. These subsections explain the advantages of using E-Lawyer over other methods of preparing these documents without the assistance of an attorney. The user can make the decisions with regard to advance planning and the attorneys at E-Lawyer will review these decision and advise the user of the advantages and disadvantages of their decisions. This is not available with the “will kits” and non-attorney web sites. The “Why you need advance planning” subsection explains the advantages of advance planning and the pitfalls of failing to do so.

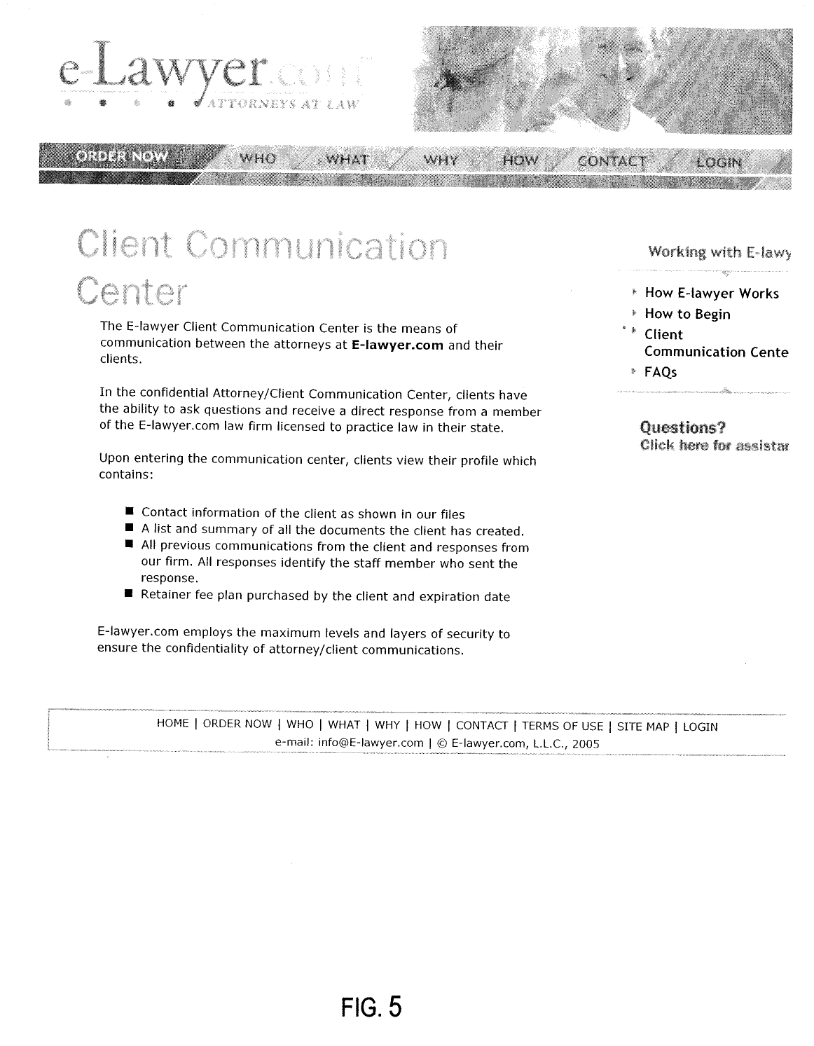

The “How” section is further broken down into “How E-Lawyer Works”; “How to Begin”; “Communication Center”; and “Frequently Asked Questions” subsections. The subsection “How E-Lawyer Works” explains how the web site works. How the user will register, login, prepare the documents, ask attorneys questions, and receive the finished documents. The “How to Begin” subsection provides a link to allow the user to fill out the questioner, register and receive their login information. The “Communications Center”, as illustrated in FIG. 5, explains how the communications center is confidential and the user can ask questions and receive direct responses from a member of the E-Lawyer law firm licensed to practice in their state. The user can also review the documents which they have created. All communications between the user and the E-Lawyer firm can also be reviewed by the user. Finally, the “Frequently Asked Questions” contain the most popular and relevant questions asked by most users.

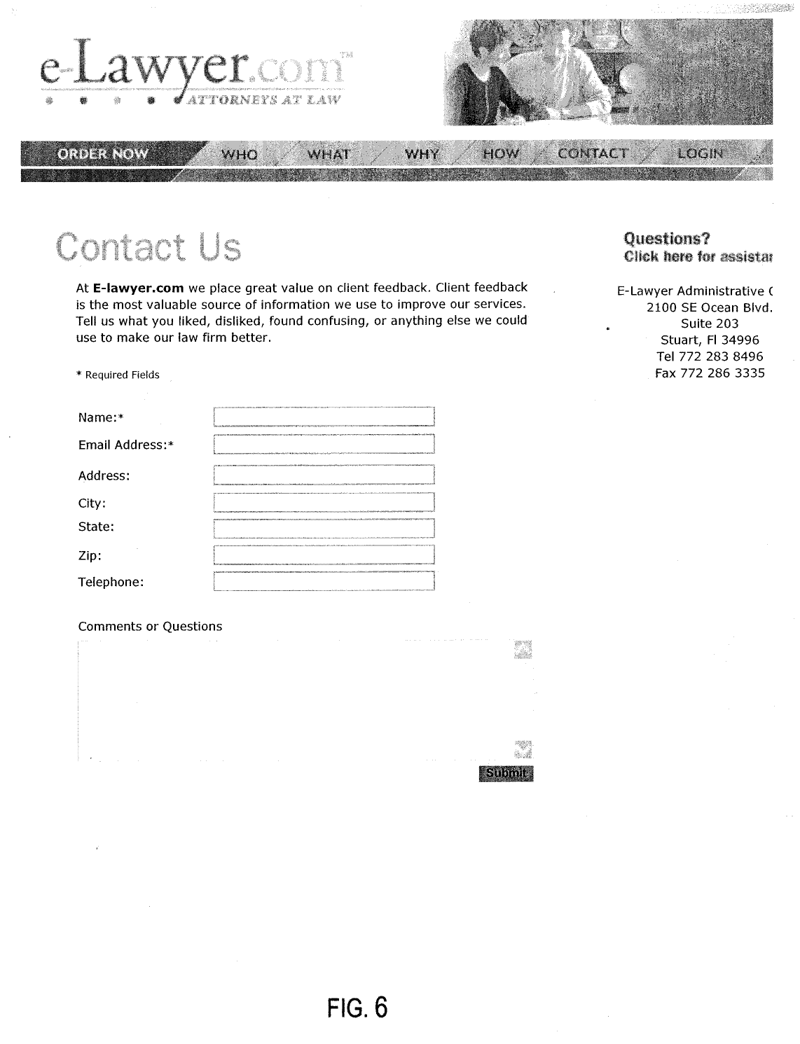

The “Contact” section, as illustrated in FIG. 6, provides a link to the “Contact Us” web page which in turn allows the user to communicate in real time with the attorneys of E-Lawyer. This allows the attorneys of E-Lawyer to respond to questions from clients as soon as the questions are presented or posted. The client can then ask another question if they are unsure of the attorney's response. This enables a back and forth communication between a client and an attorney.

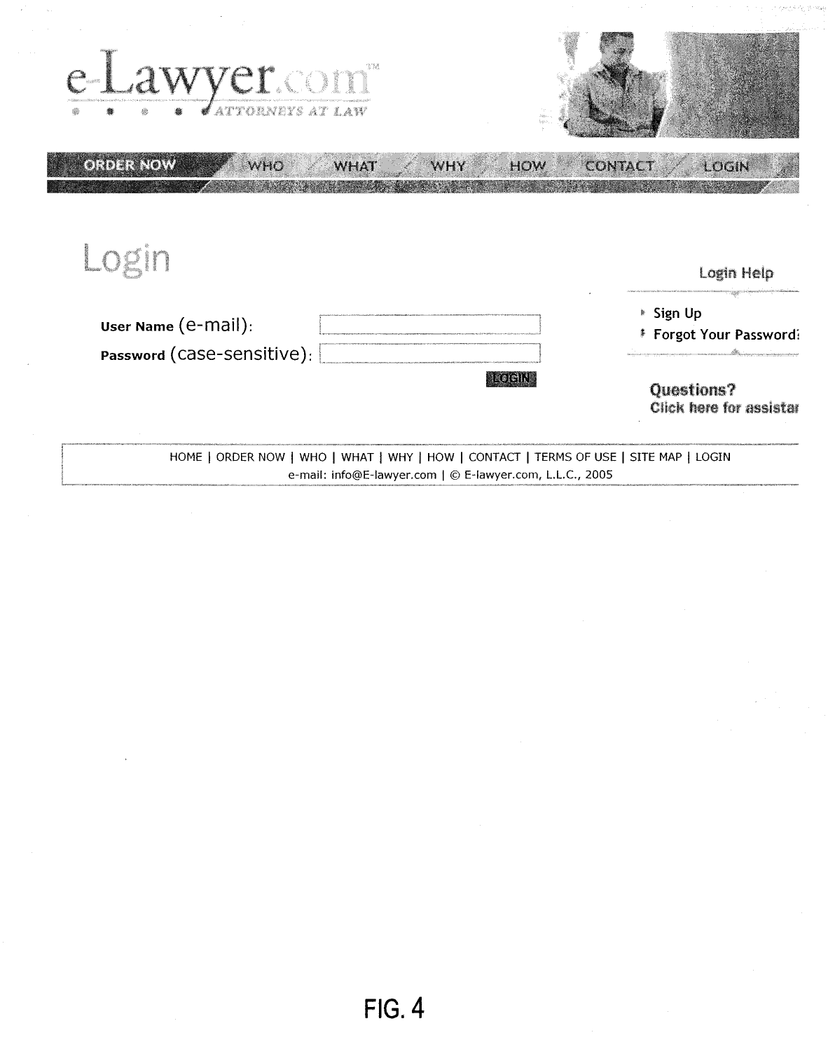

The “Login” section provides a link to the login web page, as illustrated in FIG. 4, to allow a user who has registered with the web site and received a login ID and a password to enter the secure portion of the web site.

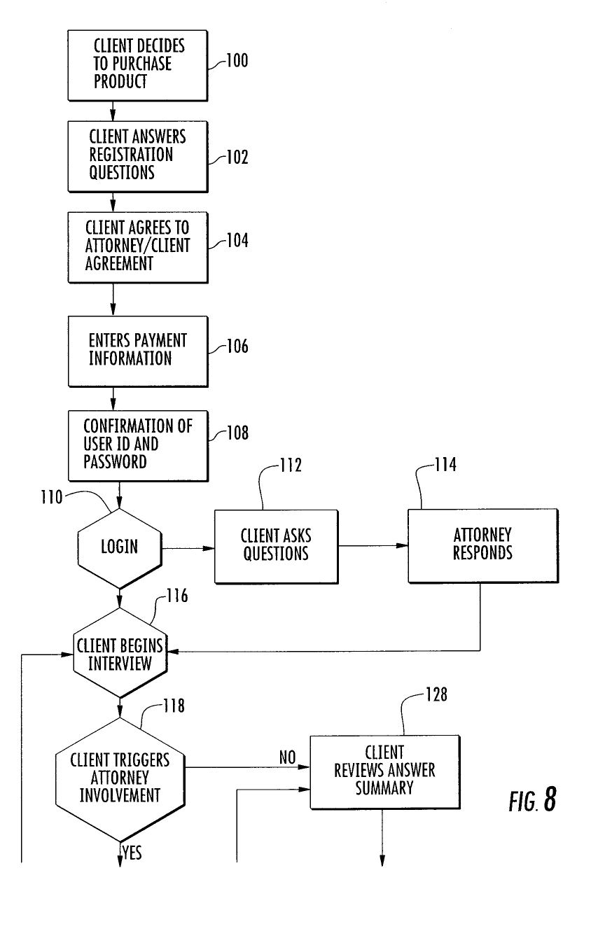

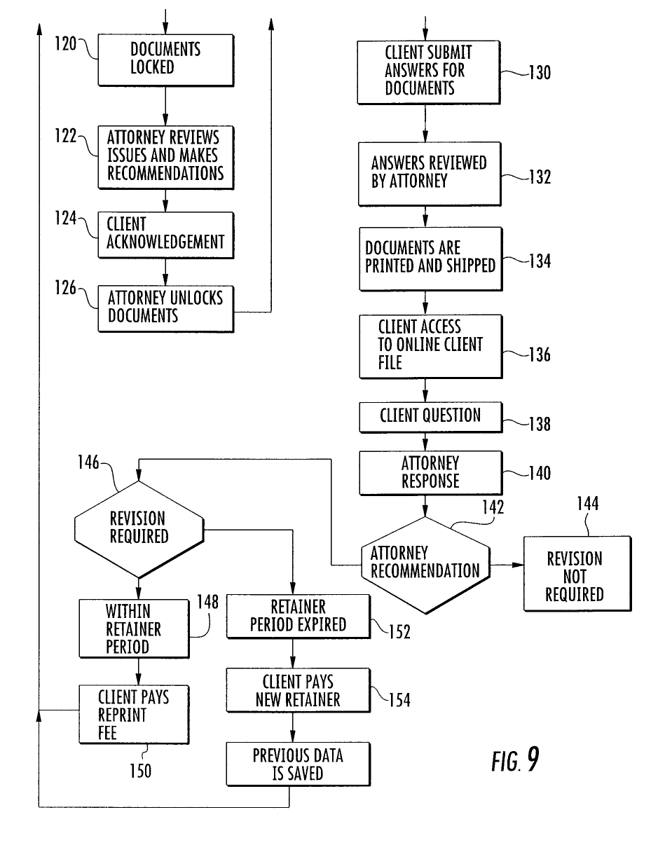

Referring to FIGS. 8 and 9 the process begins when the client decides to purchase the product which includes a package of advance planning documents and one year of legal advice at step 100. The client is then directed to a screen where they answer a number of questions for the registration process at step 102. This establishes information relating to individual clients. The client is then presented with the attorney/client agreement and if they agree to it, at step 104, they can proceed to enter the payment information at step 106. After this is confirmed the client will receive an user identification (ID) and may select a password at step 108. With the user ID and password the client can now proceed to the login screen and login to the secure portion of the website at step 110. If the client has any questions at this time they can ask them at step 112. An attorney will respond to these questions at step 114. Then the client can proceed to the interview regarding advance planning directives at step 116. If the client has no questions after they login they will proceed directly to the interview regarding advance planning directives at step 116.

The client now has the option to complete the interview by themselves or involve an attorney at step 118. Should the client choose to involve an attorney, their advance planning documents are locked, at step 120, and cannot be completed until they are unlocked by the attorney. The attorney reviews the client's advance planning requirements at step 122 and makes some recommendations to the client. The client acknowledges these recommendations at step 124 and once the attorney is aware of this acknowledgment the documents are unlocked by the attorney at step 126. The process then returns the client to step 128 wherein the client reviews their answers to the interview questions. The client may also proceed to step 128 without consulting an attorney if the client so desires.

After step 128 the client submits the interview answers to be incorporated into the documents at step 130. These answers are carefully reviewed by an attorney at step 132 to make sure that they conform to the laws and regulations of the state in which the documents are to be executed. After the review is complete, the documents are printed at step 134 and shipped to the client. The client has access to their online file at step 136 so they may see if any changes were made by an attorney. If the client has a question they can ask an attorney at step 138 and the attorney will respond at step 140. If the attorney determines that a revision of the documents is not required, at step 142, no further action is necessary and the process ends at 144. If a revision of the documents is required the process proceeds to step 146 wherein it is determined if the retainer period, which the client has purchased, is still in effect. If the period is still in effect at step 148 the client pays to have the documents reprinted, at step 150, and then returns to begin the interview process again at step 116. If the retainer period has expired, as indicated at 152, the client will purchase a new retainer and restart the period at 154. The previous data from the documents is saved and the client proceeds to the beginning of the interview at step 116 to incorporate the revisions into the documents.

A client, as referred to in this application, is defined as an individual who is not an attorney.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A network based system for providing legal services comprising:
means for providing a first set of predetermined benefits to a client who subscribes for such benefits;
means for providing an agreement to which said client must assent before said client obtains said first set of benefits;
means for obtaining client identification information prior to said client obtaining said first set of benefits; and
means to allow said client realtime access to a provider of legal services for advice.

2. The system according to claim 1, further including means to allow said client to enter payment information into said system.

3. The system according to claim 2, further including means to assign a user identification and password to said client.

4. The system according to claim 3, further including means to allow said client to enter information regarding the benefits which are to be provided to said client.

5. The system according to claim 4, further including means for an attorney to review said benefits prior to preparation of formal documents including said benefits and subsequent shipment of said documents to client.

6. The system according to claim 5, further including means to allow said attorney to modify said documents prior the presentation of said documents to said client.

7. The system of claim 1, further including means to provide said client with legal advice for a limited period of time.

8. A method for providing legal services over a network comprising:
providing a first set of predetermined benefits to a client who subscribes for such benefits;
providing an agreement to which said client must assent before said client obtains said first set of benefits;
obtaining client identification information prior to said client obtaining said first set of benefits; and
allowing said client realtime access to a provider of legal services for advice.

9. The method according to claim 8, further including allowing said client to enter payment information into said system.

10. The method according to claim 9, further including assigning a user identification and password to said client.

11. The method according to claim 10, further including allowing said client to enter information regarding the benefits which are to be provided to said client.

12. The method according to claim 11, further including permitting an attorney to review said benefits prior to preparation of formal documents including said benefits and subsequent shipment of said documents to client.

13. The system according to claim 12, further including allowing said attorney to modify said documents prior the presentation of said documents to said client.

14. The method of claim 8, further including providing said client with legal advice for a limited period of time.
